(19) United States
(12) Patent Application Publication
(10) Pub. No.: US 2026/0059041 A1
(43) Pub. Date: Feb. 26, 2026

(54) PERSON TO VEHICLE COMMUNICATION SYSTEM

(71) Applicant: FCA US LLC, Auburn Hills, MI (US)

(72) Inventors: Kristin K. Holland, Auburn Hills, MI (US); Danielle M. Brancaccio, Auburn Hills, MI (US); Victoria E. Koronkiewicz, Auburn Hills, MI (US)

(21) Appl. No.: 18/812,307

(22) Filed: Aug. 22, 2024

(51) Int. Cl. H04M 1/72436; G06V 20/62; H04M 1/2755; H04M 1/2757

(52) U.S. Cl. CPC H04M 1/72436; G06V 20/625; H04M 1/2755; H04M 1/2757; G06V 2201/08

(57) ABSTRACT

Systems and methods of communicating with a target vehicle include devices and steps to determine an identifier for a target vehicle, provide an interface by which a user-generated communication can be created, and send the user-generated communication through a communication network to the target vehicle.

### FIELD

The present disclosure relates to a system for communication by a person and to a vehicle or a person associated with the vehicle.

### BACKGROUND

For various reasons, communication may be desired by a person with an owner or other person associated with a vehicle. The communication may be to praise the vehicle, including customizations or modifications thereto, to offer support or simply to provide a positive message for the vehicle owner. Some Jeep® owners have started to leave toy ducks on vehicles that they appreciate, but this requires direct physical interaction with the vehicle of another, requires the toy ducks to be purchased and stored before they can be given out, and creates clutter and waste for the recipient if they do not want the toy duck or if they have to store the toy duck somewhere.

### SUMMARY

In at least some implementations, a method of communicating with a target vehicle includes determining an identifier for a target vehicle, providing an interface by which a user-generated communication can be created, and sending the user-generated communication through a communication network to the target vehicle.

In at least some implementations, the identifier is a vehicle identification number of the target vehicle, or the identifier is a vehicle license plate, or the identifier is a tag on or in the vehicle and visible from an exterior of the vehicle. In at least some implementations, the tag includes a code that can be read by a smartphone, or the tag is a NFC tag or a RFID tag.

In at least some implementations, the step of determining an identifier is accomplished with a camera of a smartphone. In at least some implementations, the identifier is a vehicle identification number that is determined by a program using image data from the camera.

In at least some implementations, the user-generated communication includes an image or video, a text message, or a gift or other transfer from an account of a giver to the account of a recipient associated with the target vehicle. In at least some implementations, the gift or other transfer includes one or more of a monetary gift or an e-gift card. In at least some implementations, the method also includes filtering the content of the user-generated communication to remove any profanity from the communication.

In at least some implementations, a system of a vehicle for communication with a target vehicle, includes a frontend portion and a backend portion. The frontend portion includes a data storage unit, an electronic control unit, and a communications unit by which communications are sent and received at the frontend portion. The backend portion is or is part of a cloud-based system, and includes a processor and memory. The frontend portion includes programming to determine an identifier of a target vehicle, transmit the identifier to the backend portion, receive information from the backend portion, and transmit a user-generated communication to the backend portion. And the backend portion includes programming to determine if the target vehicle is within a communication network including the backend portion, and to send the user-generated communication through the communication network to the target vehicle.

In at least some implementations, the identifier is a vehicle identification number of the target vehicle, a license plate on the target vehicle, or a tag on or in the target vehicle. In at least some implementations, the frontend portion includes a smartphone that includes programming to read the vehicle identifier. In at least some implementations, the smartphone includes a camera and the vehicle identifier is read by scanning the vehicle identifier with the camera.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle communication system for person to vehicle communications;

FIG. 2 is a diagrammatic view of a frontend portion that defines part of the system;

FIG. 3 is a diagrammatic view of the communication system; and

FIG. 4 is a flowchart of a method for person to vehicle communication.

### DETAILED DESCRIPTION

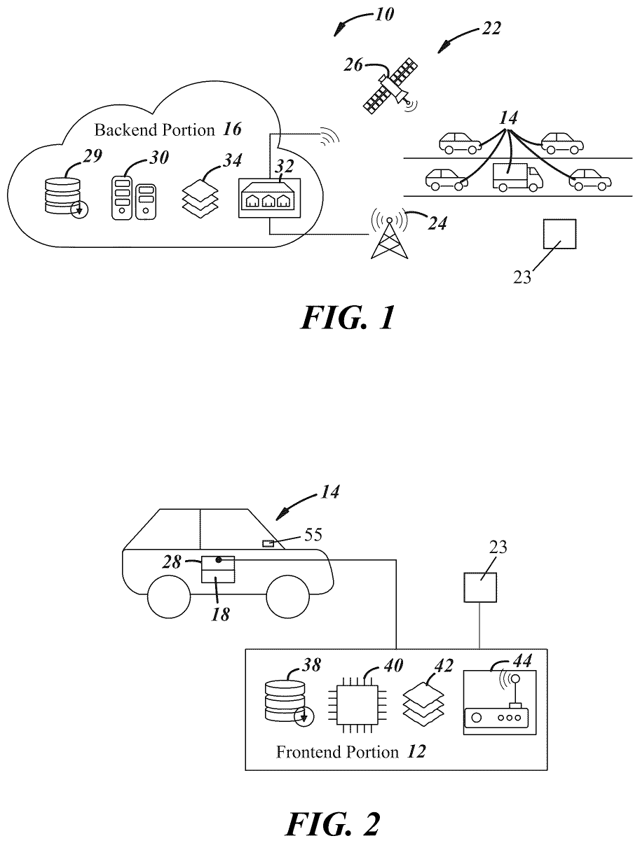

Referring in more detail to the drawings, FIG. 1 illustrates a vehicle communication system 10 including a frontend portion 12, one or more network vehicles 14 that are in communication with a backend portion 16 via one or more communication devices and suitable communication protocols. As described in more detail below, the vehicle communication system 10 may enable a user to send a communication to a specific vehicle, and this may be done via the backend portion and the frontend portion, which may be part of each network vehicle and/or a remote device 23 like a smartphone, tablet or computer, or both.

The vehicle communication system 10 may deliver hosted services via the internet and/or other communication networks and may be structured as a public, private or hybrid cloud, for example. According to one non-limiting example, vehicle communication system 10 is structured as a private cloud and generally includes the backend portion 16 and the frontend portion 12 that is distributed across a fleet of network vehicles 14 and/or among users having remote devices 23, where each network vehicle 14 or remote device 23 is capable of obtaining and providing information as well as communicating with the backend portion 16 over a secure communications network 22 (e.g., secure vehicle-to-cloud (V2C) network), and/or communicating with other vehicles via a vehicle-to-vehicle (V2V) connection. The secure communications network 22 may include a cellular-based network 24, a satellite-based network 26, a city-wide WiFi-based network, some other type of communications network and/or a combination thereof. Although only a few network vehicles 14 and one remote device 23 are shown in the drawings, it should be appreciated that system 10 may interact with a large fleet of vehicles that can include dozens, hundreds, thousands or even more vehicles, and/or a large number of users and remote devices 23. System 10 may be used with any vehicles, including (but not limited to) passenger, commercial and/or public transportation vehicles sold in any geographic area.

Backend portion 16 may include any suitable combination of software and/or hardware resources typically found in a backend of a cloud-based system, as best illustrated in FIG. 1. The backend portion 16 may be responsible for managing some of the programs and algorithms that run applications on the frontend portion 12, such as those that request, obtain and optionally analyze information of and from the network vehicles 14. It is noted that the data/information used to formulate communications and information for vehicles may be analyzed by control systems and processors on-board a network vehicle 14 or by the backend portion 16, or by a remote device 23, or combinations of these, as desired. The backend portion 16 may be managed or controlled by the vehicle manufacturer and can be part of a larger cloud-based system that the vehicle manufacturer uses to communicate and interact with a large fleet of vehicles for a multitude of purposes. For example, the backend portion 16 may include or communicate with emergency alert systems, such as those that provide Amber alerts or other missing persons alerts, or law enforcement systems that may provide and receive information regarding vehicles of interest to them.

The backend portion 16 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 16). In one example, the backend portion 16 has a number of backend resources including data storage systems 29, processors or servers 30, communication systems 32, programs and algorithms 34, as well as other suitable backend resources. It should be appreciated that backend portion 16 is not limited to any particular architecture, infrastructure or combination of elements, and that any suitable backend arrangement may be employed.

Frontend portion 12 may include any suitable combination of software and/or hardware resources typically found in a frontend of a cloud-based system, as shown in FIG. 2, and is generally responsible for sending information to the backend portion and may receive notifications, programs, instructions and the like from the backend portion 16. The frontend portion 12 is typically responsible for running the applications that interface with the users, and for interfacing with the programs and algorithms 34 of the backend portion 16. The frontend portion 12 may also be managed or controlled by the vehicle manufacturer and can be part of a larger cloud-based system that the vehicle manufacturer uses to communicate and interact with a large fleet of vehicles for various purposes, as mentioned above. The frontend portion 12 may be distributed across one or more vehicles 14 and/or users and may include any suitable combination of software and/or hardware resources including, but not limited to, components, devices, computers, modules and/or systems.

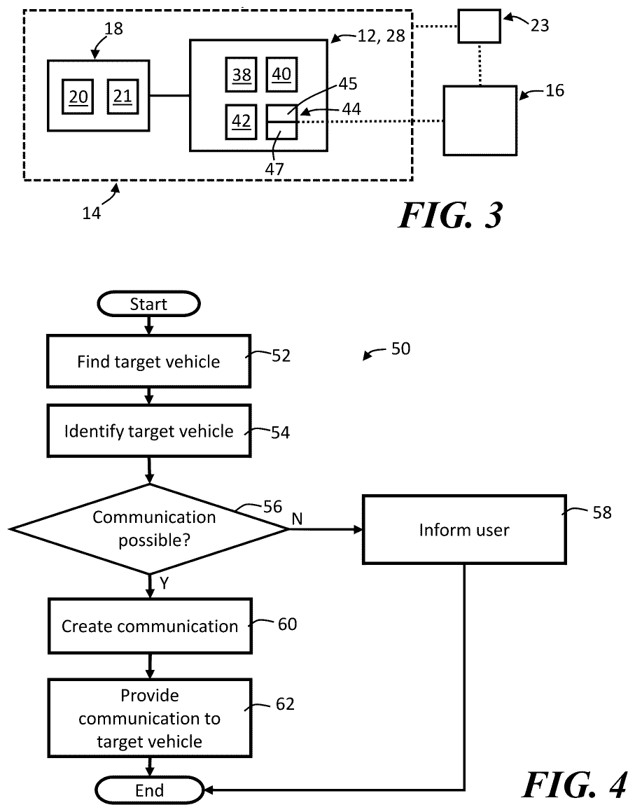

In one example, as shown in FIGS. 2 and 3, the frontend portion 12 has a number of frontend resources including a vehicle control system 28 having one or more vehicle electronic module(s) installed in vehicles 14, which may include some combination of a data storage unit 38, an electronic control unit and/or processor(s) 40, applications 42, a communications unit 44 (e.g., one that includes a telematics unit and/or other communication devices with a receiver 45 by which information is received at unit 44 and a transmitter 47 by which information is sent from the unit 44), as well as other suitable frontend resources. The network vehicles 14 may include in-vehicle infotainment (IVI) systems 18 (FIGS. 2 and 3) that utilize a combination of software and hardware components to provide a wide range of information, system controls and entertainment. As diagrammatically shown in FIG. 3, the IVI system 18 may include one or more display screens 20 and a user interface 21. The user interface may include various inputs, like buttons, switches, touch-sensitive areas of the screen 20, microphone(s) for audio or voice commands and inputs, and the like, and may define a human-machine interface for the vehicle 14.

The control system 28 may be or include a telematics box module (TBM), a telematics control module (TCM), a body control module (BCM), an electronic control unit (ECU), an infotainment control module, or any other suitable module known in the art. It is not necessary for the preceding units to be packaged in a single vehicle electronic module, as illustrated in FIG. 2; rather, they could be distributed among multiple vehicle electronic modules, they could be stand-alone units, they could be combined or integrated with other units or devices, or they could be provided according to some other configuration. It should be appreciated that frontend portion 12 is not limited to any particular architecture, infrastructure or combination of elements, and that any suitable frontend arrangement may be employed.

While some or all functions in sending a communication may be performed within the vehicle, such as by operation of the vehicle infotainment system 18 and program interface(s) provided thereby, the frontend portion 12 can also or instead by defined by remote devices 23 of users. For example, a user's smartphone can define part of the frontend portion, may include one or more processors, memory, programs and communication devices, and may communicate and interface with the backend portion 16 as noted herein.

In order to perform the functions and desired processing set forth herein, as well as the computations therefore, the frontend portion 12 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing, as generally described with regard to the frontend portion 12. For example, the frontend portion 12 may include input signal processing and filtering to enable accurate sampling and conversion or acquisitions of such signals from communications interfaces and sensors. As used herein the terms control system or controller or the like may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

For various reasons, communication may be desired by a person with an owner or other person associated with a vehicle (e.g. a registered user of the vehicle). When communication with a vehicle is noted herein, this also or instead includes communication directed to a person associated with the vehicle. For ease of reference, the vehicle in question will be called a “target vehicle 14”. The communication to be directed to the target vehicle 14 may be, by way of non-limiting examples, to express admiration or other positive message regarding a certain feature of the target vehicle 14, the type of vehicle (e.g. from one Jeep® brand vehicle owner to another), customization to the target vehicle 14 or the like. Further, the communication may be intended to be indirect, that is, sent to the target vehicle 14 or to a device 23 (e.g. smartphone, tablet, computer) or an account (e.g. email or social media) associated with the target vehicle 14 and not spoken or directly communicated in person from the sender to the target vehicle 14 owner. The communication may be intended to be anonymous, or the sender can be identified, as desired.

Recently, some owners of certain Jeep® vehicles, particularly Jeep Wrangler® vehicles have gifted to other owners a toy rubber duck (commonly a bath toy), such as by placing the rubber duck on the vehicle when the vehicle owner is not around. The intent of the gift is to provide a positive form of communication to the vehicle owner (e.g. to promote a common bond among owners of similar vehicles, show appreciation for customizations or modifications made to a vehicle, or the like, as noted above). The system and methods set forth herein can be used to provide similar communication, including “virtual ducks” and other graphics, text, video and the like, so that ducks need not be physically purchased and distributed/gifted. Among other things, this can facilitate positive communication between vehicle owners, create brand loyalty and enable a “pay it forward”mindset for people to engage with others.

FIG. 4 shows an implementation of a method 50 for communication between vehicle owners. In step 52, a target vehicle 14 is determined or located. The target vehicle 14 is the vehicle about or to which the communication should be sent for receipt by the owner/user of the vehicle. An example of identifying a target vehicle 14 is when a target vehicle 14 is in a parking lot and is seen by a user of the methods/systems who wishes to send a communication to/about the target vehicle 14.

After a target vehicle 14 is identified, in step 54, the identity or identification information for the vehicle is determined by the person wishing to send the communication. The identification information 55 (FIG. 2) may include things like the Vehicle Identification Number (VIN), a vehicle license plate, or a vehicle specific tag that may be applied to the vehicle. Some examples of a vehicle specific tag can include various types of graphic codes, like bar codes and QR codes, that are readable by a suitable device 23, like a smartphone, tablet of the like by which the tag can be scanned or read with a camera of the device and suitable software, in known manner. Similarly, suitable software can be used to determine the characters in a VIN or on a license plate (including the jurisdiction from which the license plate was issued) from image date from a camera. Further, the tag or identifier may include a NFC or RFID type tag that is readable by a smartphone 23 with suitable software.

Next, in step 56, the target vehicle 14 identification information can be used to determine if communication via the methods/systems can be initiated with the target vehicle 14. This may be done within the device that determines the identification information or by sending the identification information to the backend portion. In at least some implementation, vehicle owners can opt-in to the system to permit communication with them and absent doing so, communication through the system is not enabled. In this way, communications are only sent to people who voluntarily have agreed to receive communications through the system 10. The system 10 could instead be set up to permit owners to opt-out or turn off the option for these communications, or otherwise, as desired. In at least some implementations, the system may include a registry of vehicles for which communications are enabled.

If in step 56 it is determined that the identified target vehicle 14 is not in the registry or otherwise that communications with the vehicle are not possible or approved, then the method proceed to step 58 and inform the user that the target vehicle is not within the system and the method may thereafter end. If in step 56, it is determined that the identified target vehicle 14 is in the registry or otherwise that communications with the vehicle are possible and/or approved, then the system proceeds to step 60.

In step 60, the user composes a message to be sent to the target vehicle 14. This may be accomplished via a remote device 23, like a smartphone, table or computer, for example, and with a suitable program/interface 61 on one or both of the frontend portion and the backend portion. For example, the frontend portion/remote device 23 may include an application or “app” such as may be provided via the various app stores for iOS and android devices, by way of examples. The communication may be selected from a predetermined set of communications defined or provided within the application, which may include, by way of non-limiting examples, provided graphics, icons, images, text messages and the like, or a user may be able to compose the message include text, graphics of their choosing and from other sources, or both of these options. In at least some implementations, when a user may create message including content not provided through the application interface, the communications are filtered by suitable software (e.g. a profanity filter, an image/graphic moderator) to reduce or eliminate communication of inappropriate messages or content.

In at least some implementations, the communication may also or instead include a monetary or other gift. For example, the system may include user accounts with avatars, skins and the like, that may be upgraded by use of currency. The currency may include tokens, points or the like that have value only within the system, or actual money (e.g. US dollars, Euros, etc) or gift cards (e.g. an electronic or e-gift card) or other digital money a recipient may use to purchase goods or services. The gift may then enable a recipient to upgrade or acquire different items for their account or within the system, and user accounts and messaging may be visible/accessible by others to promote an online or virtual community of vehicle owners in the system. In this way, the user's account may include the virtual community account and/or a financial institution account (e.g. Venmo, PayPal, bank account, etc), and contributions to the account of the owner of a target vehicle 14 may be made through the system.

After the communication is prepared by the user, in step 62, the communication is sent to the target vehicle 14 or person associated therewith, and suitable confirmations can be provided to the user. The method may further include options to permit a recipient of a communication to respond to the sender, which may be done in any form or format, such as those noted herein for step 60. In at least some implementations, instead of or in addition to sending the communication to the person, vehicle or in a dedicated virtual community, the communication may be sent to or linked to one or more social media accounts of the recipient and or sender. For example, the users may link their social media accounts or other electronic or virtual account in the application interface and communications, awards, status indicators and other profile or other information may be provided on Instagram, Facebook, TikTok and the like.

In one example, a user determines a target vehicle 14, opens an app on their smartphone and is prompted by the app to scan the VIN or license plate or other tag/vehicle identifier with the camera feature of the smartphone. When the vehicle identifier is determined, it is sent to the backend portion to determine if the target vehicle 14 is within the system and eligible or otherwise setup to receive a communication through the app and application interfaces. If the target vehicle 14 is not within the system or setup for communication, the app informs the user and that is the end of the process for that target vehicle 14. If the target vehicle 14 is within the system and/or able to receive the communication, the app prompts the user to compose a message or choose an image/icon/currency to send to the target vehicle 14. When the user chooses the option in the app to send the message, the message is transmitted from the smartphone to the backend portion where the message may be analyzed and filtered (if appropriate) before being transmitted from the backend portion to the target vehicle 14 or a user/owner thereof.

In this example, the functions of the frontend portion are handled by the smartphone which includes a processor/control unit, communications unit and memory with programming to determine an identifier of a target vehicle 14, transmit the identifier to the backend portion, receive information from the backend portion, and transmit a user-generated communication to the backend portion. After identification of the target vehicle 14, the message may be composed and the application interface may be provided by the infotainment system in the vehicle which may define all or part of the frontend portion, if desired. Further, the infotainment system may be used to receive messages from other users, to access the account and permit changes to the account (e.g. program settings and user preferences), and display messages received (e.g. display virtual ducks or the like). Further in this example, the backend portion includes a cloud-based system with a processor and memory with programming to determine if the target vehicle 14 is within a communication network including the backend portion, and to send the user-generated communication through the communication network to the target vehicle 14.

In one non-limiting example, the system may enable a user to give to someone else a virtual duck, which is an image or video file or the like of a toy duck, as some Jeep owners do for other Jeep owners with actual toy ducks. Virtual ducks of different appearances or types, and/or with different characteristics can be provided for selection and giving. A virtual duck received can be saved and displayed in the virtual community (e.g. within a user's account or in discussion/chat rooms or the like) and/or they may be passed along to other users. The virtual ducks can further be shown within a vehicle, such as on one or more displays of the infotainment unit within the vehicle, or via the display of a remote device 23. Of course, icons or graphics or virtual things other than the virtual duck may be used, as desired. The virtual exchange is safer than physical interaction with a target vehicle 14, results in less clutter and waste. Physical objects, like the toy ducks, need not be purchased and then given away, and a recipient of many physical toy ducks then has to find room to store or display them, or throw them away or re-gift them, which is simplified with the use of digital communications and virtual ducks and the like.

Further, the communications and/or online community or other interface may enable like-minded users to provide positive messages to others. Among other things, this may enhance the user's vehicle experience, promote brand loyalty, provide a forum in which customizations and modification can be shared and appreciated, and the like. And this may be done in a safe, virtual setting without direct, in-person interaction between people, or between a person and the vehicle of someone else.

What is claimed is:

1. A method of communicating with a target vehicle, comprising:
determining an identifier for a target vehicle;
providing an interface by which a user-generated communication can be created;
sending the user-generated communication through a communication network to the target vehicle.

2. The method of claim 1 wherein the identifier is a vehicle identification number of the target vehicle.

3. The method of claim 1 wherein the identifier is a vehicle license plate.

4. The method of claim 1 wherein the identifier is a tag on or in the vehicle and visible from an exterior of the vehicle.

5. The method of claim 4 wherein the tag includes a code that can be read by a smartphone.

6. The method of claim 4 wherein the tag is a NFC tag or a RFID tag.

7. The method of claim 1 wherein the step of determining an identifier is accomplished with a camera of a smartphone.

8. The method of claim 7 wherein the identifier is a vehicle identification number that is determined by a program using image data from the camera.

9. The method of claim 1 wherein the user-generated communication includes an image or video, a text message, or a gift or other transfer from an account of a giver to the account of a recipient associated with the target vehicle.

10. The method of claim 9 wherein the gift or other transfer includes one or more of a monetary gift or an e-gift card.

11. The method of claim 9 which also includes filtering the content of the user-generated communication to remove any profanity from the communication.

12. A system of a vehicle for communication with a target vehicle, comprising:
a frontend portion that includes a data storage unit, an electronic control unit, and a communications unit by which communications are sent and received at the frontend portion; and
a backend portion of a cloud-based system, wherein the backend portion includes a processor and memory, wherein the frontend portion includes programming to determine an identifier of a target vehicle, transmit the identifier to the backend portion, receive information from the backend portion, and transmit a user-generated communication to the backend portion, and wherein the backend portion includes programming to determine if the target vehicle is within a communication network including the backend portion, and to send the user-generated communication through the communication network to the target vehicle.

13. The system of claim 12 wherein the identifier is a vehicle identification number of the target vehicle, a license plate on the target vehicle, or a tag on or in the target vehicle.

14. The system of claim 13 wherein the frontend portion includes a smartphone that includes programming to read the vehicle identifier.

15. The system of claim 14 wherein the smartphone includes a camera and the vehicle identifier is read by scanning the vehicle identifier with the camera.
